(19) United States
(12) Patent Application Publication
(10) Pub. No.: US 2012/0290365 A1
(43) Pub. Date: Nov. 15, 2012

(54) SYSTEM FOR SELECTING EMPLOYMENT CANDIDATES

(75) Inventors: William L. Bramlett, JR., Tolar, TX (US); Brian C. Giedt, Grand Prairie, TX (US); Joseph M. Kistner, Waco, TX (US)

(73) Assignee: PROFILES INTERNATIONAL, INC., Waco, TX (US)

(21) Appl. No.: 13/107,176

(22) Filed: May 13, 2011

(51) Int. Cl. G06Q 10/00

(52) U.S. Cl. 705/7.42

(57) ABSTRACT

A computer system receives data relating to a plurality of persons. The persons are employed in the same occupation. A portion of the persons is top performers in the occupation, and a portion of the persons is bottom performers in the occupation. The data relates to personal traits and performance traits. The data is input into a software-based neural network, and the neural network generates models for the personal traits as a function of the personal traits and the performance traits of the top performers. The neural network further generates a performance model, which is made up of the models. The performance model is configured to determine that a particular person will likely be a top performer in the occupation.

### TECHNICAL FIELD

The present disclosure relates to a system for selecting employment candidates.

### BACKGROUND

A business organization that has to select among a pool of candidates to fill job openings is in an unenviable position. Specifically, it is very difficult in the typical rather short evaluation process to identify the candidates that will truly have the best potential for success in a particular job position. Indeed, such employment decisions are normally based only on academic transcripts, a resume, a written recommendation or two, and an in person interview.

Additionally, current systems that attempt to assist in the employee selection process tend to focus only on one definition of a potentially successful candidate. Such systems have difficulty identifying outliers, that is, candidates who are not identified according to the system's standards, but nevertheless would make a potentially successful candidate. Moreover, attempts to broaden the standards or lower the threshold, in an attempt to capture these outliers, seem to identify candidates as potentially successful when they simply are not.

The art is therefore in need of a system that can more accurately and effectively identify persons who would excel in a particular job or a particular occupation.

### BRIEF DESCRIPTION OF THE DRAWINGS

FIGS. 1 and 1A are a flowchart of an example embodiment of a process to identify a candidate for a particular occupation.

FIGS. 2 and 2A are a flowchart of another example embodiment of a process to identify a candidate for a particular occupation.

FIG. 3 is an example embodiment of an output of a performance model generated by a neural network.

FIGS. 4 and 4A are example embodiments of an output of a list of candidates and scores for the candidates.

FIG. 5 is an example embodiment of an output of a particular candidate and scores for that candidate for several occupations.

FIG. 6 is an example embodiment of an output comparing a candidate to other candidates.

FIG. 7 is an example embodiment of a computer system upon which one or more embodiments of the present disclosure can execute.

### DETAILED DESCRIPTION

Biological neural networks are made up of neurons that are connected or functionally related in the peripheral nervous system or the central nervous system. In the field of neuroscience, neural networks are often identified as groups of neurons that perform a specific physiological function.

Artificial neural networks are made up of interconnecting artificial neurons, that is, programming constructs that mimic the properties of biological neurons. Artificial neural networks can be used to gain an understanding of biological neural networks, or for solving artificial intelligence problems without necessarily creating a model of a real biological system. The tasks to which artificial neural networks are applied tend to fall into the following categories. A first category includes function approximation, or regression analysis, including time series predicting and modeling. A second category includes classification, including pattern and sequence recognition, novelty detection, and sequential decision making. A third category includes data processing, including filtering, clustering, and blind signal separation and compression. The third category can further include system identification and control (vehicle control, process control), pattern recognition (radar systems, face identification, and object identification), sequence recognition (gesture, speech, handwritten text), medical diagnoses, financial applications, data mining, visualization, email spam filtering, and game playing and decision making.

An artificial neural network is trained to recognize multiple patterns that may be desirable, and distinguish these desirable patterns from other patterns that are not desirable. It is this technique of artificial neural networks that can be applied to one or more embodiments that identify a potentially successful candidate for a particular profession. Such artificial neural networks can be obtained from software companies that specialize in the design and implementation of such neural networks. Such companies normally can design and construct a customized neural network based on the needs of a particular customer, or modify and adapt a basic neural network to the needs of such a customer. For example, two such neural network providers are NeuralWare of Carnegie, Pa., and StatSoft of Tulsa, Okla.

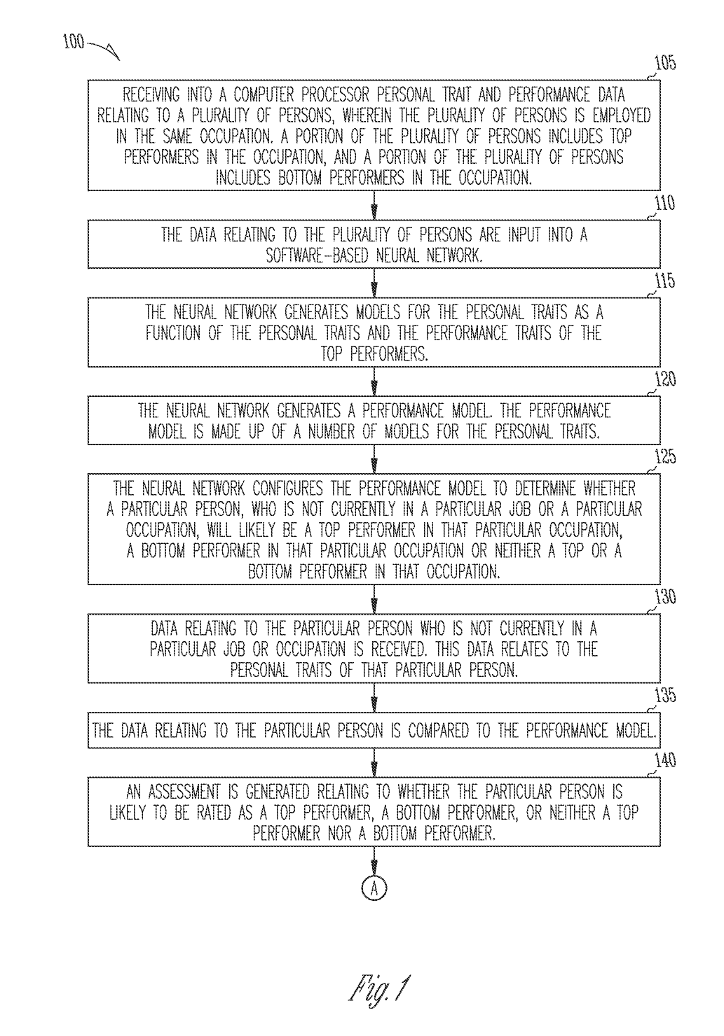

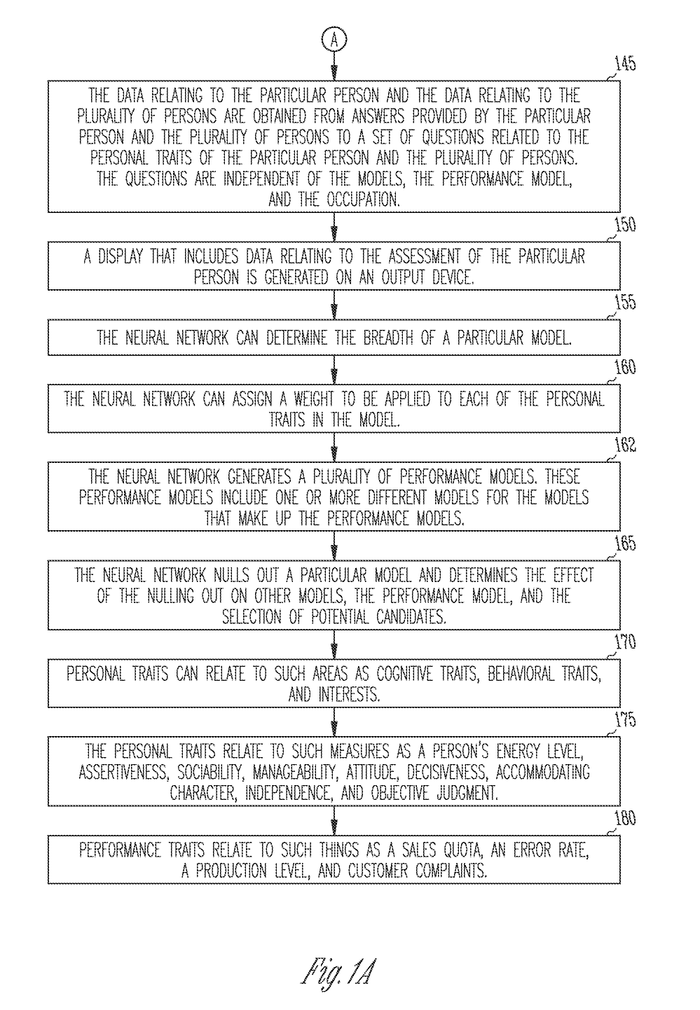

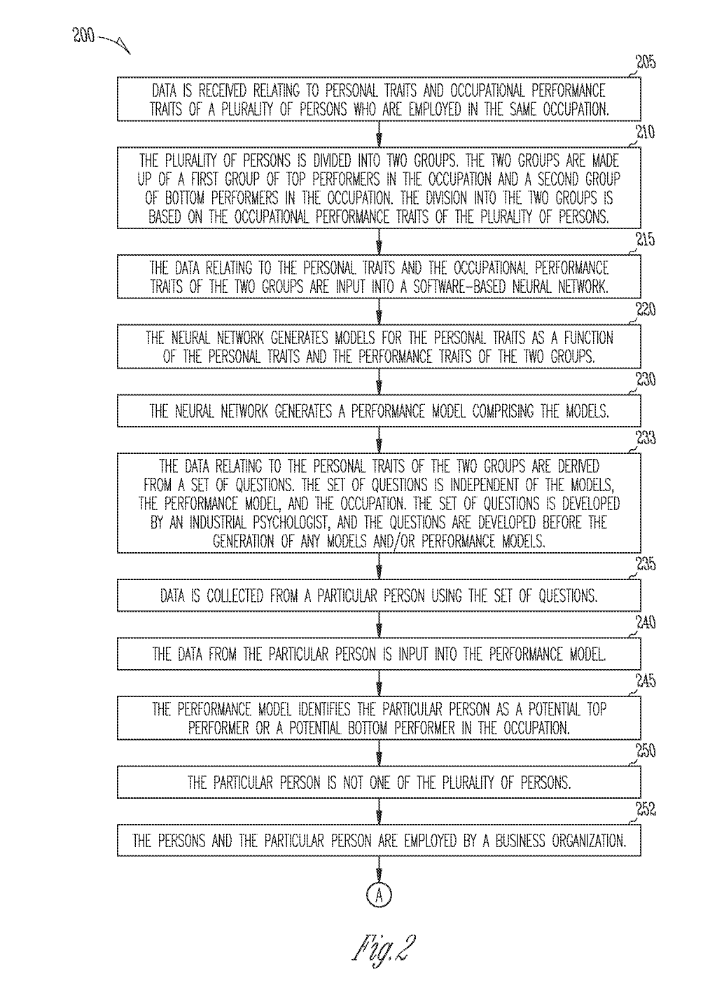

FIGS. 1, 1A, 2, and 2A are flowcharts of example processes 100 and 200 for using a neural network to select employees for a particular job or occupation. The processes 100 and 200 can identify the candidates who are most likely to be the top performers in a particular job or occupation. This identification is accomplished by using the neural network to model the personal and performance traits of known top performers in the occupation, and comparing a candidate for a job or occupation to the model. FIGS. 1, 1A, 2, and 2A include a number of process blocks 105-180 and 205-290 respectively. Though arranged serially in the example of FIGS. 1, 1A, 2, and 2A, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring now specifically to FIGS. 1 and 1A, the process 100 includes at 105 receiving into a computer processor data relating to a plurality of persons. The persons are employed in the same occupation. A portion of the persons includes top performers in the occupation, and a portion of the persons includes bottom performers in the occupation. The data relates to one or more of personal traits and performance traits. Personal traits can relate to such areas as cognitive traits, behavioral traits, and interests (170). More specifically, the personal traits can relate to such measures as a person's energy level, assertiveness, sociability, manageability, attitude, decisiveness, accommodating character, independence, and objective judgment (175). Performance traits can relate to such things as a sales quota, an error rate, a production level, and customer complaints involving the person (180).

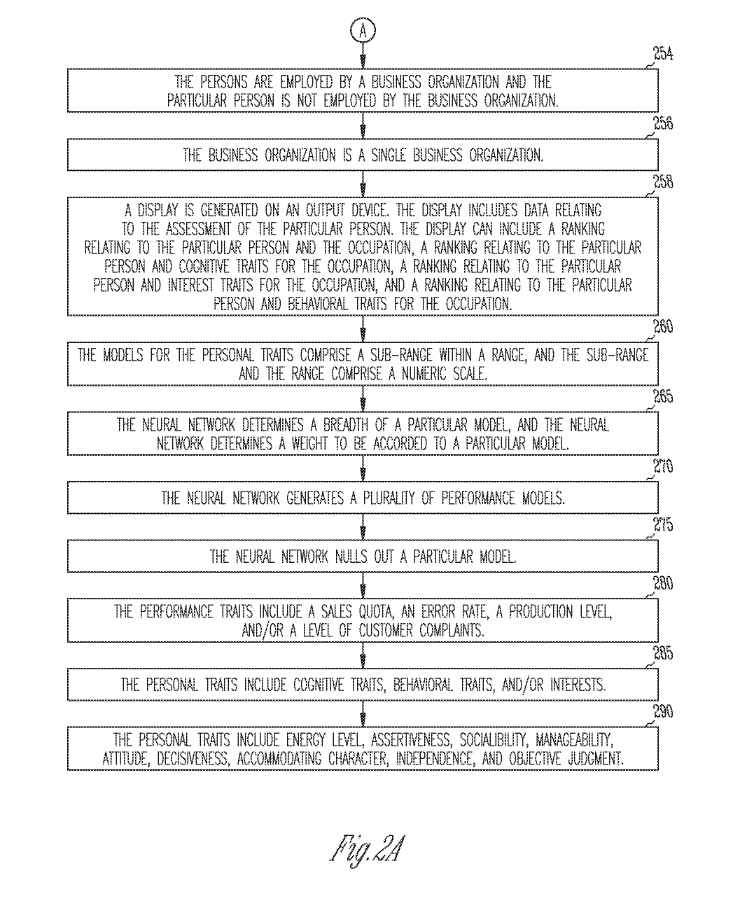

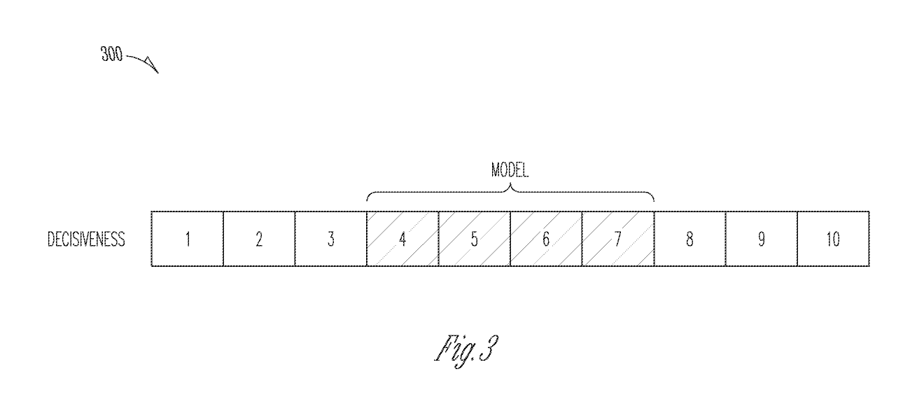

At 110, the data relating to the plurality of persons are input into a software-based neural network. At 115, the neural network generates models for the personal traits as a function of the personal traits and the performance traits of the top performers. An example of such a model 300 for the personal trait of decisiveness is illustrated in FIG. 3. Specifically, the neural network derives the model 300, based on the personal traits and performance traits of the plurality of persons, and in particular the top performers of the plurality of persons, by analyzing responses to questions relating to decisiveness from the top performers. As can be seen in FIG. 3, the neural network has identified that top performers in the pertinent occupation range from a score of 4 to 7 for the personal trait of decisiveness. That is, the model for decisiveness is the 4-7 range.

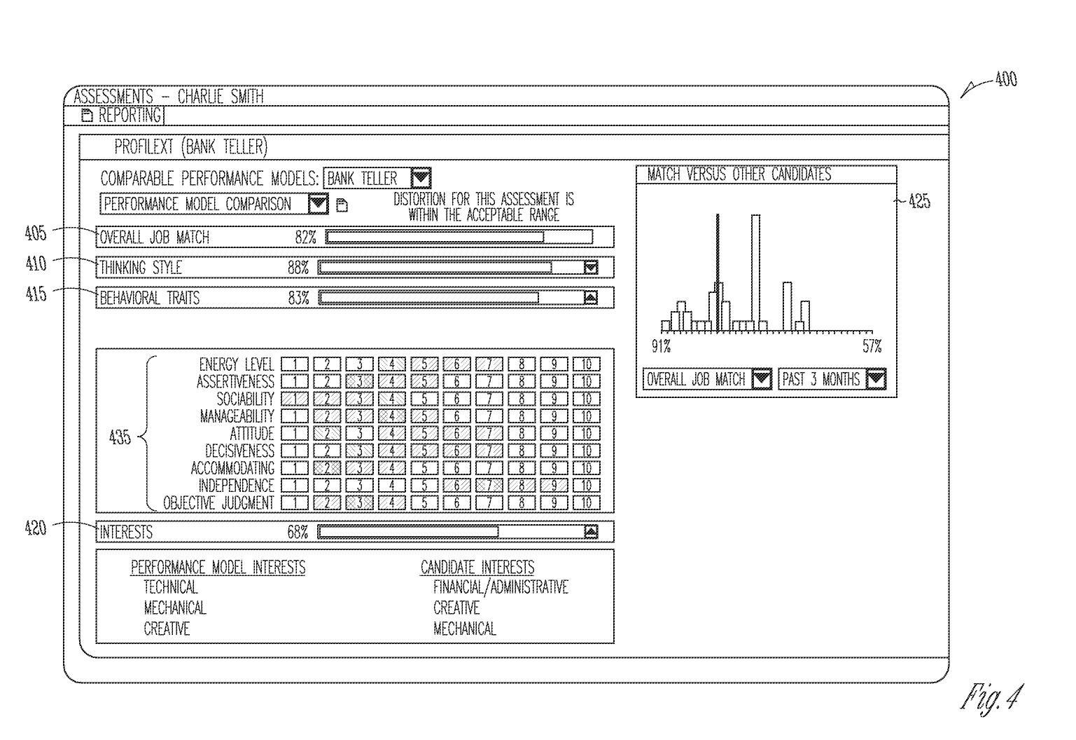

At 120, the neural network generates a performance model. The performance model is made up of a number of models for the personal traits. An example of a performance model 400 is illustrated in FIG. 4. As can be seen in FIG. 4, the performance model 400 includes nine personal trait models 435—energy level, assertiveness, sociability, manageability, attitude, decisiveness, accommodating character, independence, and objective judgment. Each personal trait model is identified by a particular range, such as the energy level model is identified by the range of 5-7, as indicated by the right leaning slash marks over those range numbers. In this manner, at 125, the neural network configures the performance model to determine whether a particular person, who is not currently in a particular job or a particular occupation, will likely be a top performer in that particular occupation, a bottom performer in that particular occupation, or neither a top performer or a bottom performer in that particular occupation.

At 130, data relating to the particular person who is not currently in a particular job or occupation is received. This data relates to the personal traits of that particular person. At 135, the data relating to the particular person is compared to the performance model 400. At 140, an assessment is generated relating to whether the particular person is likely to be rated as a top performer, a bottom performer, or neither a top performer nor a bottom performer.

At 145, the data relating to the particular person and the data relating to the plurality of persons are obtained from answers provided by the particular person and the plurality of persons to a set of questions related to the personal traits of the particular person and the plurality of persons. In an embodiment, these questions are independent of the models, the performance model, and the occupation. At 150, a display that includes data relating to the assessment of the particular person is generated on an output device. These displays include many different forms.

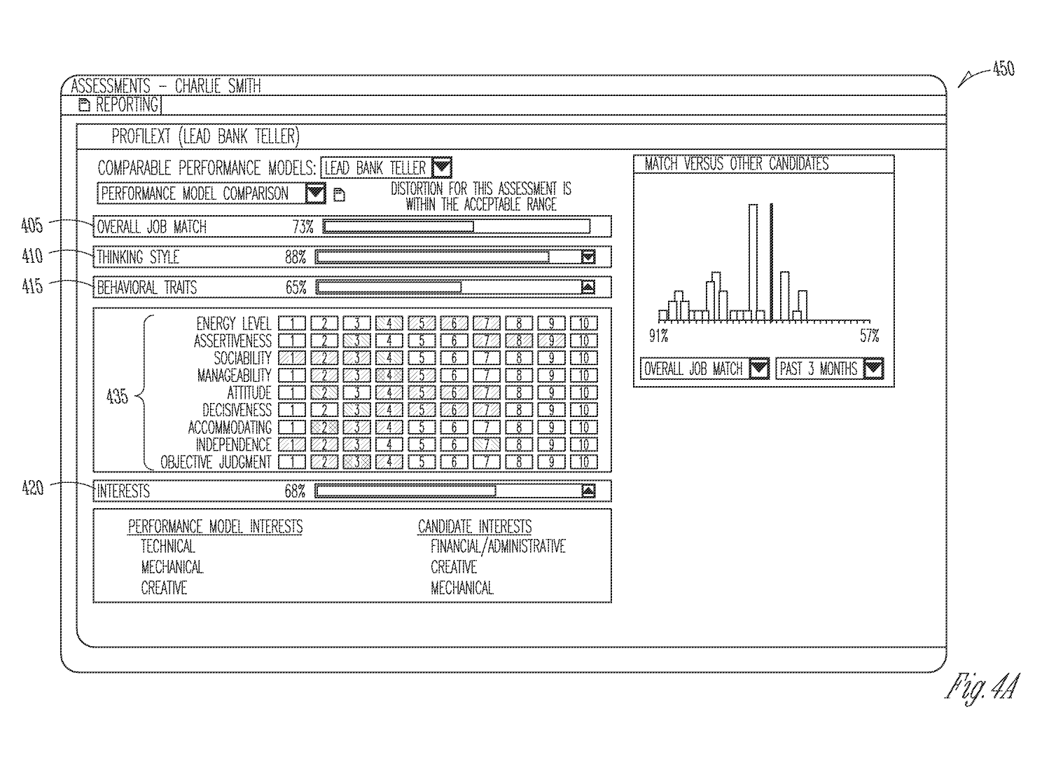

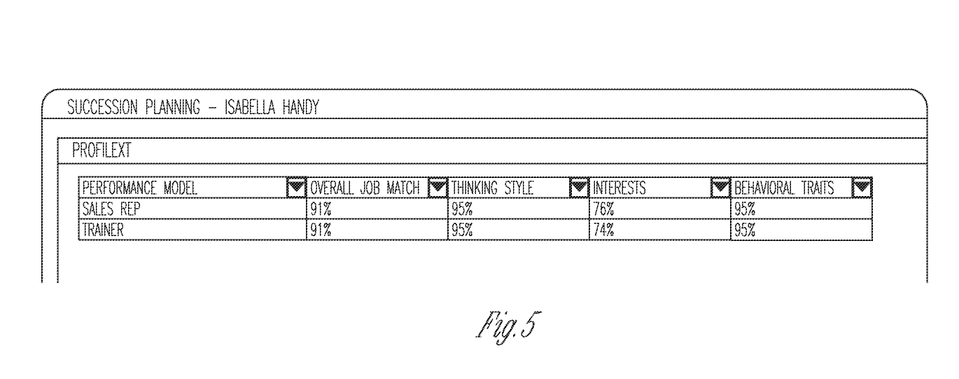

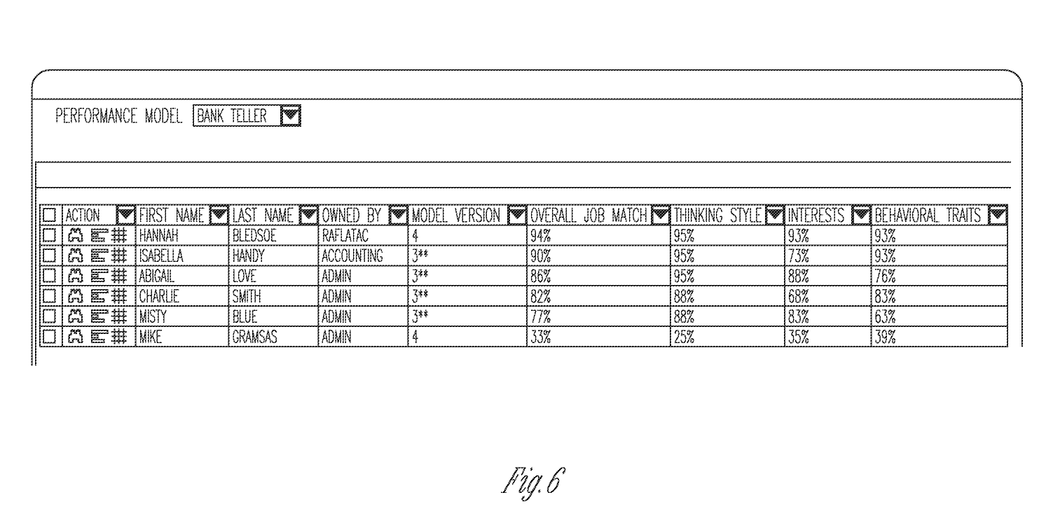

For example, the display can be the performance model 400, and the performance model can indicate how, for each personal trait, the particular person compares to the models generated by the neural network (using the personal trait data of the top performers in the pertinent occupation). The performance model 400 in FIG. 4 further shows that for this particular person, Charlie Smith, his overall job match 405 for the occupation of a bank teller is 82%. That is, there is an 82% chance that Charlie Smith will be a top performer or successful candidate as a bank teller. In an embodiment, this job match percentage is determined by calculating the percentage of personal trait character model ranges into which the candidate falls. In another embodiment, different portions of the range such as lower, middle, or upper are weighted more heavily than other portions of the model range. Similarly, Mr. Smith's thinking style 410, behavioral traits 415, and interests 420 fall into the models generated using the personal traits of the top performers 88%, 83%, and 68% of the time respectively. FIG. 4 further illustrates Mr. Smith's match versus other candidates in the bar graph at 425. As the bar graph 425 shows, this candidate's job match was 82% as compared with matching percentages of other candidates. The bar graph 425 further shows that the most common job match percentage for this example was 76%. FIG. 4 further illustrates how a particular person compares with each of the personal trait models 435, generated by the neural network using the personal trait data of the top and bottom performers. For example, in FIG. 4, Mr. Smith fell outside the range for energy level, sociability, attitude, decisiveness, and accommodating character, as indicated by the left leaning slashes in the pertinent boxes within each model (4 for energy level, 4 for sociability, 2 for attitude, 3 for decisiveness, and 2 for accommodating character). FIG. 4 further illustrates that Mr. Smith fell within the range for assertiveness, manageability, accommodating character, independence, and objective judgment, as indicated by the cross-hatched lines in the pertinent boxes within each model (3 for assertiveness, 4 for manageability, 7 for independence, and 3 for objective judgment). The displayed output can further indicate a particular person's rankings related to a plurality of occupations as illustrated in FIG. 5, and a comparison of several different persons regarding job match percentages, cognitive traits, interests, and behavioral traits for a particular occupation, such as a bank teller as illustrated in FIG. 6.

As further indicated in the performance model of FIG. 4, the neural network generates a range relating to a particular personal trait, such as from 1-10 for the personal traits 435 in FIG. 4. Then, based upon the personal trait data relating to the top performers, the neural network generates a sub-range within this range. The sub-range serves as the actual model. As noted in this example, the sub-range and the range are a numeric scale. In another embodiment, as indicated at 155, the neural network can determine the breadth of a particular model. In FIG. 4, the neural network has determined that the breadth of the assertiveness personal trait is three, while the breadth of the independence personal trait is four. Similarly, at 160, the neural network can assign a weight to be applied to each of the personal traits in the model. Once again, the neural network determines the breadth of each personal trait model and the weight to assign to each personal trait model based on the data of the bottom and top performers for this occupation.

At 160, the neural network generates a plurality of performance models. These performance models include one or more different models for the models that make up the performance models. The plurality of performance models makes it less likely that an outlier candidate will be missed. For example, FIG. 4A illustrates another performance model 450. The performance model 450 was generated by the neural network using the data relating to the top and bottom performers, just like the performance model 400 of FIG. 4 was generated. The neural network determined that the data for the top and bottom performers indicate that top bank tellers display an assertiveness ranking of 3-5 and 7-9, and an independence ranking of 1-3 and 6-9. Consequently, the neural network generated a performance model 400 to identify potential top bank tellers, wherein the assertiveness and independence rankings are 3-5 and 6-9 respectively, and a performance model 450 to identify top bank tellers, wherein the assertiveness and independence rankings are 7-9 and 1-3 respectively. At 165, the neural network nulls out a particular model and determines the effect of the nulling out on other models, the performance model, and the selection of potential candidates.

FIG. 2 illustrates another example embodiment of a process 200 that uses a neural network to select employees for a particular job or occupation. At 205, data is received relating to personal traits and occupational performance traits of a plurality of persons who are employed in the same occupation. At 210, the persons are divided into two groups. The two groups are made up of a first group of top performers in the occupation and a second group of bottom performers in the occupation. The division into the two groups is based on the occupational performance traits of the plurality of persons. At 215, the data relating to the personal traits and the occupational performance traits of the two groups are input into a software-based neural network. At 220, the neural network generates models for the personal traits as a function of the personal traits and the performance traits of the two groups, and at 230, the neural network generates a performance model comprising the models. At 233, it is noted that the data relating to the personal traits of the two groups are derived from a set of questions. The set of questions is independent of the models, the performance model, and the occupation. In an embodiment, the set of questions is developed by an industrial psychologist, and in another embodiment the questions are developed before the generation of any models and/or performance models.

After the generation of the performance model, the following steps are executed. At 235, data is collected from a particular person using the set of questions. At 240, the data from the particular person are input into the performance model, and at 245, the performance model identifies the particular person as a potential top performer or a potential bottom performer in the occupation.

At 250, it is noted that the particular person is not one of the plurality of persons. At 252, the plurality of persons and the particular person are employed by a business organization, at 254, the plurality of persons is employed by a business organization and the particular person is not employed by the business organization, and at 256, the business organization is a single business organization.

At 258, a display is generated on an output device. The display includes data relating to the assessment of the particular person. The display can include a ranking relating to the particular person and the occupation, a ranking relating to the particular person and cognitive traits for the occupation, a ranking relating to the particular person and interests for the occupation, and a ranking relating to the particular person and behavioral traits for the occupation.

At 260, the models for the personal traits comprise a sub-range within a range, and the sub-range and the range comprise a numeric scale. At 265, the neural network determines a breadth of a particular model, and the neural network determines a weight to be accorded to a particular model.

At 270, the neural network generates a plurality of performance models. In this plurality of performance models, each performance model is configured to identify the particular person as a potential top performer. As noted above, a plurality of performance models can be used to assist in capturing any outliers in the group. At 275, the neural network nulls out a particular model. The neural network can then determine the effect the nulling out of the particular model has on the other models, the performance model, and the selection of a particular candidate. At 280, the performance traits include a sales quota, an error rate, a production level, and/or a level of customer complaints. At 285, the personal traits include cognitive traits, behavioral traits, and/or interests. At 290, the personal traits include energy level, assertiveness, sociability, manageability, attitude, decisiveness, accommodating character, independence, and objective judgment.

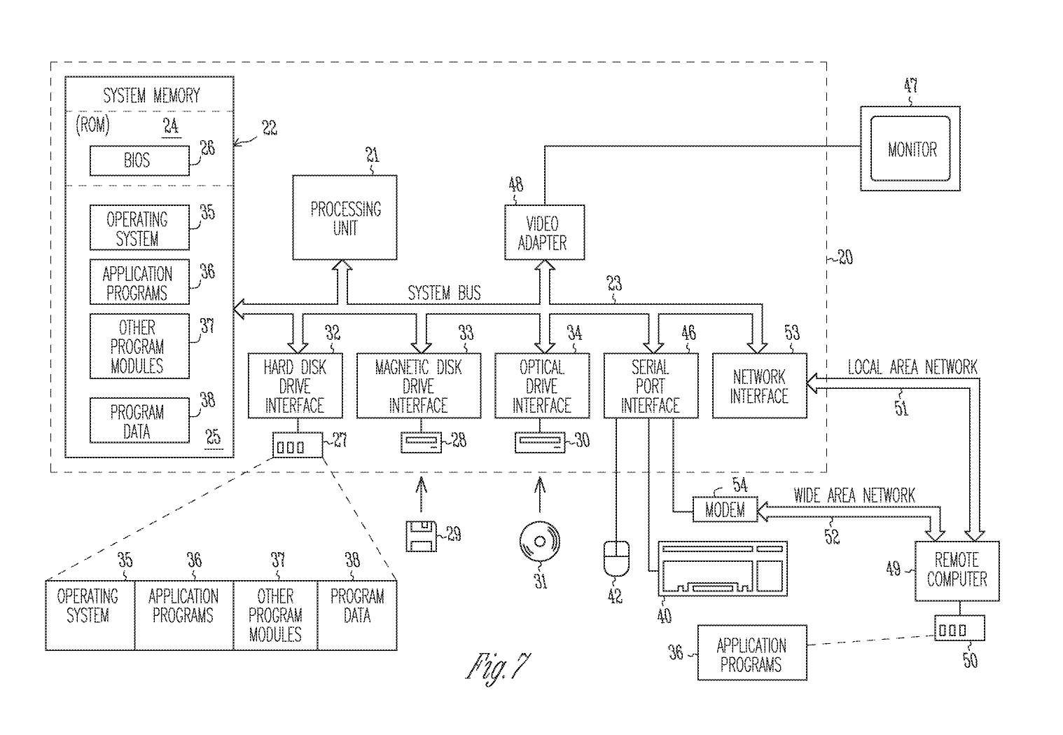

FIG. 7 is an overview diagram of a hardware and operating environment in conjunction with which embodiments of the invention may be practiced. The description of FIG. 7 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCS, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 7, a hardware and operating environment is provided that is applicable to any of the servers and/or remote clients shown in the other Figures.

As shown in FIG. 7, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above I/O relative to the computer 20, although only a memory storage device 50 has been illustrated. The logical connections depicted in FIG. 7 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A system comprising:
one or more computer processors configured for:
receiving data relating to a plurality of persons, the plurality of persons employed in the same occupation, a portion of the plurality of persons comprising top performers in the occupation, and a portion of the plurality of persons comprising bottom performers in the occupation, wherein the data relates to one or more of personal traits and performance traits;
inputting the data into a software-based neural network;
using the neural network to generate models for the personal traits as a function of the personal traits and the performance traits of the top performers; and
using the neural network to generate a performance model comprising the personal traits models;
wherein the performance model is configured to determine that a particular person, who is not one of the plurality of persons, will likely be a top performer in the occupation, a bottom performer in the occupation, or neither a top performer or a bottom performer.

2. The system of claim 1, comprising using the performance model to identify particular person as a potential top performer or a potential bottom performer.

3. The system of claim 2, comprising one or more computer processors configured for:
receiving data relating to the particular person, wherein the data relates to the personal traits;
comparing the data of the particular person to the performance model; and
generating an assessment of whether the particular person is likely to be rated as a top performer, a bottom performer, or neither a top performer nor a bottom performer.

4. The system of claim 3, wherein the data relating to the particular person and the data relating to the plurality of persons are obtained from answers provided by the particular person and the plurality of persons to a set of questions that are independent of the models, the performance model, and the occupation.

5. The system of claim 3, comprising one or more computer processors for generating a display on an output device, the display including data relating to the assessment of the particular person.

6. The system of claim 5, wherein the display comprises one or more of a ranking relating to the particular person and the occupation, a ranking relating to the particular person and cognitive traits for the occupation, a ranking relating to the particular person and interests for the occupation, and a ranking relating to the particular person and behavioral traits for the occupation.

7. The system of claim 1, wherein the models for the personal traits comprise a sub-range within a range.

8. The system of claim 7, wherein the sub-range and the range comprise a numeric scale.

9. The system of claim 7, comprising using the neural network to determine a breadth of a particular model.

10. The system of claim 7, comprising using the neural network to determine a weight to be accorded to a particular model.

11. The system of claim 1, comprising using the neural network to generate a plurality of performance models, each performance model configured to identify the particular person as a potential top performer.

12. The system of claim 1, comprising using the neural network to null out a particular model and to determine the effect of the nulling out on other models.

13. The system of claim 1, wherein the performance traits comprise one or more of a sales quota, an error rate, a production level, and a level of customer complaints.

14. The system of claim 1, wherein the personal traits comprise one or more of cognitive traits, behavioral traits, and interests.

15. The system of claim 14, wherein the personal traits comprise one of more of energy level, assertiveness, sociability, manageability, attitude, decisiveness, accommodating, independence, and objective judgment.

16. A system comprising:
one or more computer processors configured for:
receiving data relating to personal traits and occupational performance traits of a plurality of persons who are employed in the same occupation;
dividing the plurality of persons into two groups, the two groups comprising a first group of top performers in the occupation and a second group of bottom performers in the occupation, wherein the division into the two groups is based on the occupational performance traits of the plurality of persons;
inputting the data relating to the personal traits and the occupational performance traits of the two groups into a software-based neural network;
using the neural network to generate models for the personal traits as a function of the personal traits and the performance traits of the two groups; and
using the neural network to generate a performance model comprising the personal traits models;
wherein the data relating to the personal traits of the two groups are derived from a set of questions that are independent of the models and the performance model and independent of the occupation.

17. The system of claim 16, wherein the set of questions is developed by an industrial psychologist independently of the generation of the models and the performance model.

18. The system claim 16, comprising one or more computer processors configured for, after the generation of the performance model:
collecting data from a particular person using the set of questions;
inputting the data from the particular person into the performance model; and
using the performance model to identify the particular person as a potential top performer or a potential bottom performer in the occupation.

19. The system of claim 18, wherein the particular person is not one of the plurality of persons.

20. The system of claim 18, wherein the plurality of persons and the particular person are employed by a business organization.

21. The system of claim 18, wherein the plurality of persons is employed by a business organization, and the particular person is not employed by the business organization.

22. The system of claim 20 or 21, wherein the business organization is a single business organization.

23. The system of claim 18, comprising one or more computer processors for generating a display on an output device, the display including data relating to the assessment of the particular person.

24. The system of claim 23, wherein the display comprises one or more of a ranking relating to the particular person and the occupation, a ranking relating to the particular person and cognitive traits for the occupation, a ranking relating to the particular person and interests for the occupation, and a ranking relating to the particular person and behavioral traits for the occupation.

25. The system of claim 16, wherein the models for the personal traits comprise a sub-range within a range.

26. The system of claim 25 wherein the sub-range and the range comprise a numeric scale.

27. The system of claim 25, comprising one or more computer processors configured for using the neural network to determine a breadth of a particular model.

28. The system of claim 25, comprising using the neural network to determine a weight to be accorded to a particular model.

29. The system of claim 16, comprising using the neural network to generate a plurality of performance models, each performance model configured to identify the particular person as a potential top performer.

30. The system of claim 16, comprising using the neural network to null out a particular model and to determine the effect of the nulling out on other models.

31. The system of claim 16, wherein the performance traits comprise one or more of a sales quota, an error rate, a production and a level of customer complaints.

32. The system of claim 16, wherein the personal traits comprise one or more of cognitive traits, behavioral traits, and interests.

33. The system of claim 32, wherein the personal traits comprise one of more of energy level, assertiveness, sociability, manageability, attitude, decisiveness, accommodating, independence, and objective judgment.

34. A system comprising:
one or more computer processors configured for:
receiving into a computer processor data relating to a plurality of persons, the plurality of persons employed in the same occupation, a portion of the plurality of persons comprising top performers in the occupation, and a portion of the plurality of persons comprising bottom performers in the occupation, wherein the data relates to one or more of personal traits and performance traits;
inputting the data into a software-based neural network;
using the neural network to generate models for the personal traits as a function of the personal traits and the performance traits of the top performers; and
using the neural network to generate a performance model comprising the personal traits models;
wherein the performance model is configured to determine that a particular person will likely be a top performer in the occupation.

35. A tangible computer readable storage device comprising instructions that when executed by a processor execute a process comprising:
receiving data relating to a plurality of persons, the plurality of persons employed in the same occupation, a portion of the plurality of persons comprising top performers in the occupation, and a portion of the plurality of persons comprising bottom performers in the occupation, wherein the data relates to one or more of personal traits and performance traits;
inputting the data into a software-based neural network;
using the neural network to generate models for the personal traits as a function of the personal traits and the performance traits of the top performers; and
using the neural network to generate a performance model comprising the personal traits models;
wherein the performance model is configured to determine that a particular person, who is not one of the plurality of persons, will likely be a top performer in the occupation, a bottom performer in the occupation, or neither a top performer or a bottom performer.

36. A tangible computer readable storage device comprising instructions that when executed by a processor execute a process comprising:
receiving data relating to personal traits and occupational performance traits of a plurality of persons who are employed in the same occupation;
dividing the plurality of persons into two groups, the two groups comprising a first group of top performers in the occupation and a second group of bottom performers in the occupation, wherein the division into the two groups is based on the occupational performance traits of the plurality of persons;
inputting the data relating to the personal traits and the occupational performance traits of the two groups into a software-based neural network;
using the neural network to generate models for the personal traits as a function of the personal traits and the performance traits of the two groups; and
using the neural network to generate a performance model comprising the personal traits models;
wherein the data relating to the personal traits of the two groups are derived from a set of questions that are independent of the models and the performance model and independent of the occupation.

37. A tangible computer readable storage device comprising instructions that when executed by a processor execute a process comprising:
receiving into a computer processor data relating to a plurality of persons, the plurality of persons employed in the same occupation, a portion of the plurality of persons comprising top performers in the occupation, and a portion of the plurality of persons comprising bottom performers in the occupation, wherein the data relates to one or more of personal traits and performance traits;
inputting the data into a software-based neural network;
using the neural network to generate models for the personal traits as a function of the personal traits and the performance traits of the top performers; and
using the neural network to generate a performance model comprising the personal traits models;
wherein the performance model is configured to determine that a particular person will likely be a top performer in the occupation.

38. The system of claim 1, wherein the one or more computer processors are configured for calculating a job match percentage by determining a percentage of personal trait character model ranges into which a job applicant falls.

39. The system of claim 7, comprising two or more sub-ranges within a range of a personal trait model.
